(19) United States
(12) Patent Application Publication
(10) Pub. No.: US 2007/0160187 A1
(43) Pub. Date: Jul. 12, 2007

(54) System and method for redirecting a telecommunicating party to an information source over a computer network

(75) Inventors: Frederick Paul Kneipp, Davenport, NH (US); Malcom Strandberg, Cambridge, MA (US); W. James Gillis JR., Andover, MA (US); Judith A. Dunn, Westford, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Aspect Software, Inc., Westford, MA (US)

(21) Appl. No.: 11/347,792

(22) Filed: Feb. 3, 2006

Related U.S. Application Data
(60) Provisional application No. 60/754,486, filed on Dec. 28, 2005.

(51) Int. Cl. H04M 3/00; H04M 5/00

(52) U.S. Cl. 379/265.01

(57) ABSTRACT

A system and method for providing an access code to an interested party who is engaging in communications with a call center agent over a communications line and directing the interested party to at least one source of information provided over a computer network. The interested party may make an inquiry or otherwise contact a call center via a telephone call or by inquiring over the internet. A web server or other system may itself determine that an interested party is in need of information or direction. Various embodiments of the invention envision that the source of information includes at least one web page, an on-line electronic chat session over the computer network, or automated navigation of a web site.

### CROSS-REFERENCE TO RELATED APPLICATIONS

The present application claims priority from U.S. provisional patent application Ser. No. 60/754,486, filed Dec. 28, 2005, by Frederick P. Kneipp et al., incorporated by reference herein and for which benefit of the priority date is hereby claimed.

### FIELD OF THE INVENTION

The present invention relates to telephony systems and more particularly, to a system and method for uniquely connecting an interested party to an alternate and supplemental source of information such as an on-line chat session or to a web page provided over a computer network.

### BACKGROUND OF THE INVENTION

Telephony call centers that place outbound calls and receive inbound calls typically utilize a telephone call center management system to help automate much of the process. The telephone call center management system automatically connects inbound calls from interested parties to an available call center agent. The telephone call center management system also controls, among other functions, the dialing of outbound telephone numbers from a predefined, sorted, call list having a number of customer call records within each call list. These customer call lists may be downloaded from a call record source, such as a host computer, to the telephone call center management system once during a 24-hour period, often during the non-busy early hours of the morning. Typically, calls passing through the telephone call center management system are continuously downloaded for dynamic updating of call records within a call list. The telephone call center management system automatically connects outbound calls to available operators or agents for handling.

In the past, the overwhelming majority of customers or potential customers (collectively “interested parties”) contacted the call center by telephone to obtain information, either on their own or the result of an outbound telephone calling campaign. These interested parties were calling for many different reasons. For example, the interested parties might have wanted information on the company's products or services, or may want information on their existing account with the company. Often there were no agents available at the company to provide the requested information, and the interested party waited on hold for an available agent, received the information by way of recorded messages, or had to call back at another time.

With the advent of global or large scale computer networks such as the Internet (also known as the World Wide Web), it is now possible for companies to provide information “on-line” that is accessible to interested parties via a data terminal (e.g. a PC) connected to the network. A company may provide “on-line” information about products and/or services that might be of interest, as well as information on the status of a party's account. One way of providing on-line information is with hypertext documents on the World Wide Web created using Hypertext Markup Language (HTML). By browsing through these “web pages” using the data terminal, the interested party can obtain information in the form of text, graphics and/or sound.

Although the Internet or other such computer network provides an additional medium for communicating information to interested parties, a party may still initiate communications by dialing a telephone number and being connected to an agent at a call center or by being called by a call center. Nonetheless, it may be more efficient to direct them to a specific web page that contains information that the interested party desires or to an electronic chat session where a topic of interest is being discussed. In this manner, the agent assisting the interested party during the telephone conversation can continue to provide the interested party the desired information in an interactive, controlled format, while also allowing the call center management system to collect additional data on the interested party for storage and possible later usage. Telecommunications charges can be minimized and overall call center efficiency can be increased by diverting calls that would otherwise require the assistance of a live agent to other sources of information, such as the web pages or chat sessions mentioned above. In addition, because of the inherent pauses during chat room conversations or web page usage, a single agent is able to handle multiple interested parties at once, thus eliminating the need for many callbacks and lengthy phone delays. Interrupted sessions can be easily rejoined through use of the unique access code.

Provision of a unique access code also provides a mechanism to limit access to account information, personal information or information of a particular subject matter of interest only to a specific party.

As the usage of the Internet and other global computer networks increases, an increasing number of individuals will become more comfortable obtaining information using such media, even when their initial contact with a source of information utilizes a more traditional telecommunications medium, such as the placing or receiving of a standard telephone call.

### SUMMARY OF THE INVENTION

The present invention features a system and method for providing a unique access code to an interested party who is engaging in communications with a call center agent over a communications line and directing the interested party to an alternative source of information provided over a computer network. In one embodiment, the alternative source of information includes at least one web page. Another embodiment envisions that a call center agent will also access the alternative source of information and aid the interested party in navigating the alternative source of information using an on-line electronic chat session over the computer network. Alternatively, an automated script may be provided to aid an interested party in web site navigation.

In yet another embodiment, the interested party may make an inquiry or otherwise contact a call center in a more general manner other than a telephone call such as, for example, by inquiring over the internet, in which case the interested party could also be directed to an alternative source of information using the internet connection established by the interested party.

### BRIEF DESCRIPTION OF THE DRAWINGS

These and other features and advantages of the present invention will be better understood by reading the following detailed description, taken together with the drawings wherein:

FIG. 1 is a schematic block diagram of one embodiment of an interested party redirection system used to interface an interested party with at least one alternative source of desired information over a computer network;

FIG. 2 is a schematic block diagram of one embodiment of the interested party redirection system of FIG. 1;

FIG. 3 is a fragmentary illustration of one possible data cell utilized in the present invention; and

FIG. 4 is a flow chart illustrating one embodiment of a method for directing a party who is engaging in communications with a call center agent over a communications line to an alternative source of information provided over a computer network.

### DETAILED DESCRIPTION OF THE INVENTION

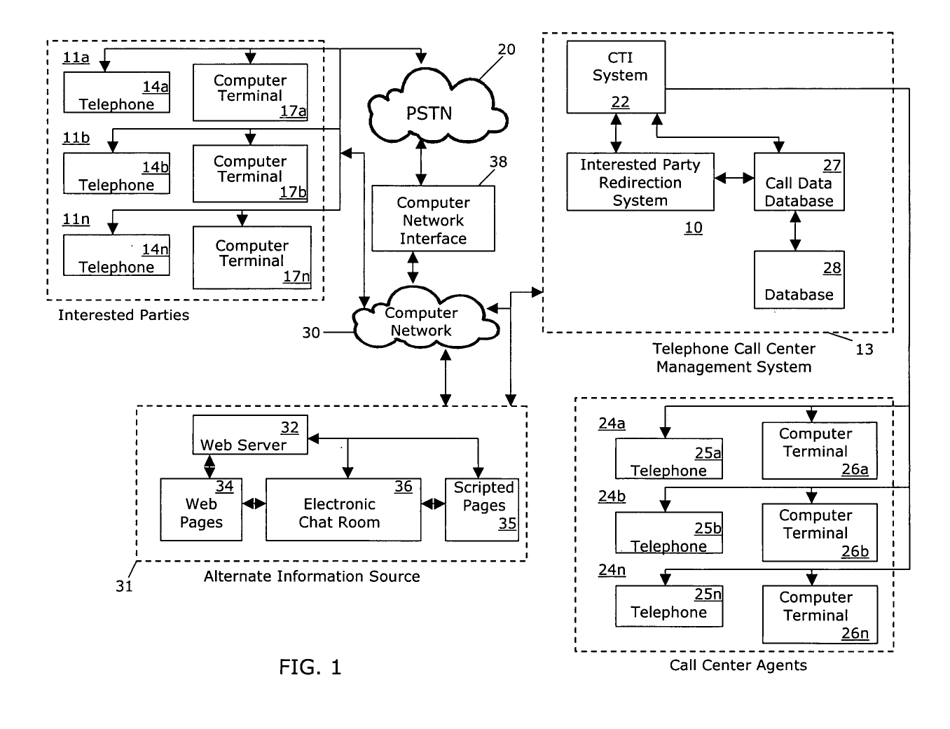

The interested party redirection system 10 (FIG. 1) according to one embodiment of the present invention, provides an additional source of information to an interested party 11a-11n who is engaged in communications with a call center agent 24a-24n to an alternative source of information 31 that is provided over a computer network 30.

In the described embodiment, the interested party redirection system 10 is shown as part of the telephone call management system 13, although this is not a limitation of the present invention as the interested party redirection system 10 may be implemented by a third party on a third system/server such as web server 32.

In the exemplary embodiment of FIG. 1, the computer network 30 is the Internet/World-Wide-Web, although the present invention contemplates other types of computer networks that are accessed by “dial up” connections over telephone lines, broadband cable connections, Local Area Networks (LANs), Wide Area Networks (WANs) as well as direct network connections.

In many cases, the interested party computer 17a-17n accesses the computer network 30 over the Public Switched Telephone Network (PSTN) 20 via a computer network interface 38. However, additional means of connecting to the computer network 30, such as T1, ISDN, DSL, Broadband connections and the like are considered to be within the scope of the present invention, and need not be routed through the PSTN 20.

A request or need to be redirected to an additional information source 31 typically occurs when the interested party 11 is engaged in communications with the call center agent 24. During the communications, the interested party 11 communicates with the call center agent 24 using an interested party telephone 14 that is connected to a call center agent telephone 25 via the PSTN 20 and computer telephony integration (CTI) system 22 that is typically part of a call center.

A CTI system may include an automated call distributor including such well-known features as a PBX for incoming calls and/or automated dialing for outgoing calls. An exemplary call center with which the present invention may be utilized is the Unison® Call Center Management System available through Davox Corporation.

The communication may be a voice communication automatically initiated by the CTI system 22 as part of an outbound call to an interested party 11, or by the interested party 11 who has placed an inbound call to a telephone call center management system and who has been connected to the call center agent telephone 25 by the CTI system 22.

In another embodiment, the interested party may contact the call center management system via the computer network 30 using the World-Wide-Web and the interested party's computer 17. Such might occur, for example, if the interested part was on a web page and either asked for additional information or help, such as by “clicking on a button” or by the web server directly interrogating the interested party about or offering the interested party additional information about a topic or by the web server itself recognizing that the user may be having difficulty navigating the web site and/or finding the information needed by, for example, monitoring the various web pages accessed by the interested party.

In either case, during the exchange of communications, the call center agent 24 may advise the interested party 11 or the interested party may inquire as to the availability of additional information regarding the subject matter of the communication. The interested party redirection system 10 is then used to assist and control in the redirection of the interested party to at least one source of additional information that is available over the computer network 30.

One source of additional information may be one or more ongoing, electronic chat sessions between one or more call center agents 24 and one or more interested parties 11 using an Internet-enabled chat room 36, provided by one or more World-Wide-Web (WWW) servers 32. Other additional information sources include one or more web pages 34, not necessarily from the same site (collectively referred to as a “web site”), provided by web server 32, which may provide general information of concern to the interested party and scripted web pages or web page guides 35 which provide agent controlled information.

For example, if a communication is concerned with a customer service issue, a call center agent may advise an interested party that there is an ongoing electronic chat session regarding the specific customer service issue of concern to the interested party and may suggest to the interested party that he or she may wish to join the chat session. The call center agent could also advise the interested party of an on-line troubleshooting guide that may be provided on the Internet that could be of assistance in solving the interested party's specific problem.

Additionally, there may be an interactive web site that can be simultaneously accessible by both an interested party and a call center agent that could provide desired information in a manner whereby the call center agent would direct the navigation of the web site in real time in response to input received from the interested party via the web site.

As an example, interested party may telephone Ashopping company on their telephone number and is directed to agent Sally to speak about boots, the item of interest. Sally gives interested party code 20 which she obtains from the interested party redirector 10. The caller then goes to the Ashopping.com web site and fills in a personal code box with the number 20, which will redirect the interested party's web browser to Ashopping's web page about boots and optionally a photo of agent Sally and a chat window in which Sally may have already entered a personal greeting. Although a number is shown as a code, this is not a limitation as a name, phrase or word may also be used.

A third party system, such as a web server 32 may also act as a redirector. For example, interested party calls Ashopping company on their telephone number and is directed to agent Sally to speak about boots, the item of interest. Sally gives interested party code “fun.a.com” which she obtains from the third party redirector 10. The caller then goes to the fun.a.com. The third party redirector known the code “fun” and links the interested party to the boot page of Ashopping.com web site which will redirect the interested party's web browser to Ashopping's web page about boots and optionally a photo of agent Sally and a chat window in which Sally may have already entered a personal greeting. This exemplary embodiment is an opportunity for a third party to act as a redirection system, particularly if the third party has a catchy name.

In addition to providing access and directions to the interested party, the telephone call center management system also captures and stores information relating to the interested party communication. Calls from interested parties pass through the CTI system 22, which in addition to the interested party redirection system 10, contains a call data memory 27, which collects information related to the interested party call, and database 28, which organizes and stores data, both present and historical, on interested party calls. The information provided from the interested party redirection system 10 is added to the call data memory 27 and stored for later reference in the database 28.

A call center agent 24 may interface either directly or indirectly to either the computer network 30 or the web server 32. In one embodiment, the call center agent's computer terminal 26 includes a web browser, which allows the call center agent to access a web-based alternative information source at his or her computer terminal 26.

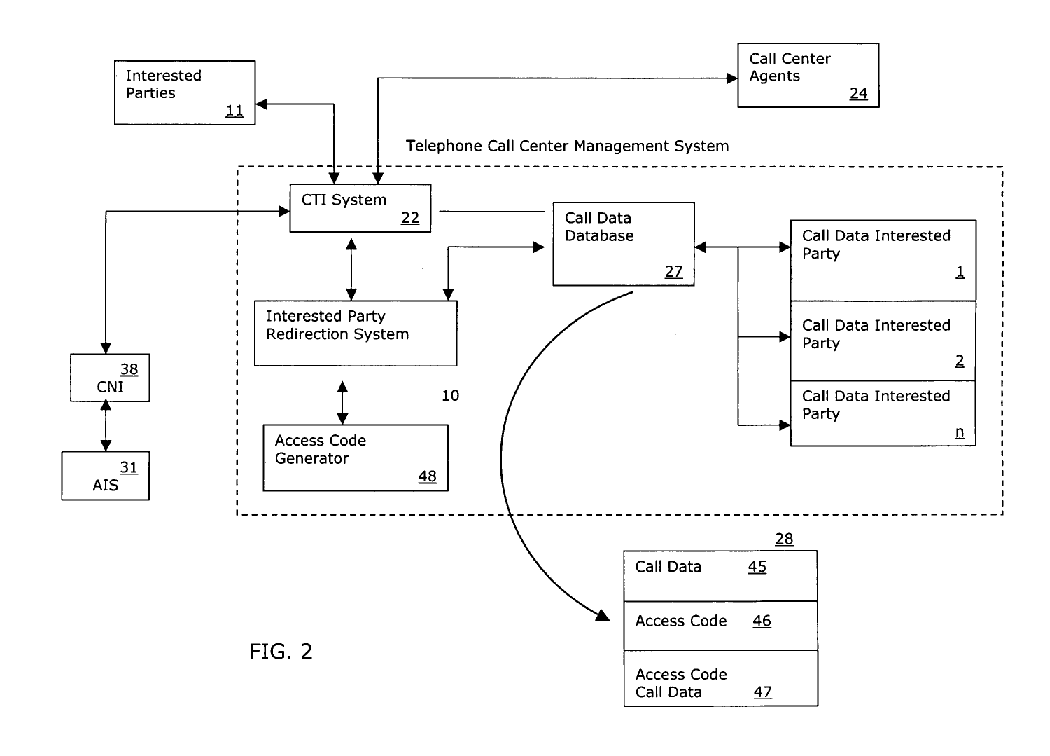

In one embodiment, the interested party redirection system 10, FIG. 2, includes an access code generator 48, also connected to CTI system 22, for generating an access code to be provided to the interested party 11 by the call center agent 24 engaging in the initial communications with the interested party. As will be discussed in more detail below, the access code, which may be unique of fixed for a particular area of interest, is used by the interested party redirection system 10 to identify an interested party accessing the additional source of information so that the information stored in the call data database 27 or in the database 28 maintained by the CTI system can be retrieved in order to facilitate the provision of the specific additional information desired by the interested party over the computer network. The interested party redirection system 10 connects to a computer network interface 38 to allow the system 10 to access the additional information source 31 over the computer network 30 (FIG. 1).

In addition to the CTI system 22, the interested party redirection system 10 connects to a call data database 27, also connected to CTI system 22, in which information relating to an information request is held, including any unique access code assigned. This information may be matched to existing call data 45 contained in database 28, and later saved in the database 28 as unique access code 46 for subsequent matching to any use of the unique access code by the interested party, which generates additional unique access code call data 47.

In this manner, when an interested party accesses an additional information source via the computer network, the agent assigned by the CTI system to assist in the navigation of the additional information source or the one or more call center agents engaged in an on-line chat session will have ready access to information regarding the interested party that may assist the agent in providing the desired/required additional information to the interested party. As previously mentioned, the system of the present invention may automatically provide this feature without the involvement of a call center agent.

When a request for redirection to an additional information source is made, the interested party redirection system 10 and, specifically the access code generator 48, generates an unique access code which is provided to the interested party over the connection. Once assigned, unique access codes are stored in the database 28 so that future information requests can be readily identified as well as matched to existing information already in the database regarding the interested party. Along with the unique access code, an interested party is provided with directions from the call center or the call center agent engaged in the initial communications as to how to access the desired additional information source.

For example, the interested party may be instructed to log onto a specific web site and may be provided with the URL (uniform resource locator) of that web site. Alternatively, the present invention may automatically direct the interested party to the desired/required additional information via the web server 32. The directions may also include the specific steps that the interested party should take to enter an electronic chat room.

In any event, after the initial communication with the call center agent, the interested party may access the additional information source, either immediately or at a later date/time. The interested party will use the access code (or web address) that she or he has been provided with in order to log onto or access the additional information source. Once logged on or accessed, the additional information source 31 will contact the interested party redirection system 10 (FIG. 1) via computer network 30 in order to advise the system that an interested party is seeking information from the additional information source. Upon receipt of such notification, the redirection system 10 will so advise the CTI system 22, which will respond in a manner appropriate to the specific type of additional information that is requested.

For example, an additional information request may dictate that the call center agent engaged in the initial communication with the interested party should assist the interested party in navigating the additional information source or should participate in an on-line chat session. In such cases, the CTI system will so notify the particular call center agent(s) and assign them to participate in the provision of the additional information over the computer network. This may be accomplished by connecting the agent data terminal 26 (FIG. 1) to the additional information source 31 via the computer network interface 38 over the computer network 30 and allowing the call center agent to interact with the additional information source, e.g. web server 32.

It is understood that the inclusion of the call data memory 27 and database 28 and the use of unique access codes to identify specific interested parties will allow call center agents other than the agent who handled the initial communications with the interested party to effectively assist in the provision of the additional information over the computer network.

Since, as mentioned above, it is envisioned that less than all of the interested parties that indicate a desire to access an additional information source over the computer network will in fact access that source of additional information and since there are finite memory capacities inherent in all computer systems, unique access codes may include built in expiration times. For example, an assigned unique access code/word may expire after 1, 6, 12, 24 or more hours after it is assigned.

In other embodiments of the invention, it is envisioned that, upon accessing the additional source of information and entering the assigned unique access code, an agent (which may be the same agent that conversed with the interested party or a different agent) may engage in an electronic chat session with the interested party and assist the interested party in navigating the additional information source.

In another embodiment of the invention, it is envisioned that one or more additional information sources will include built in, automated navigation scripts, which will guide an interested party in navigating the additional information source without requiring call center agent interaction. Of course, such an embodiment could be configured to automatically modify or tailor scripts in response to specific information obtained from an interested party during the initial communication. In this case, the access codes could also be utilized to identify a specific script to be utilized.

In addition, scripts could be configured to interact with the CTI system via the computer network 30 and the computer network interface 38 to allow call record information to be retrieved and utilized in a running script. In a more simple embodiment, an assigned access code would simply allow an interested party to view static information provided on one or more web pages or the like.

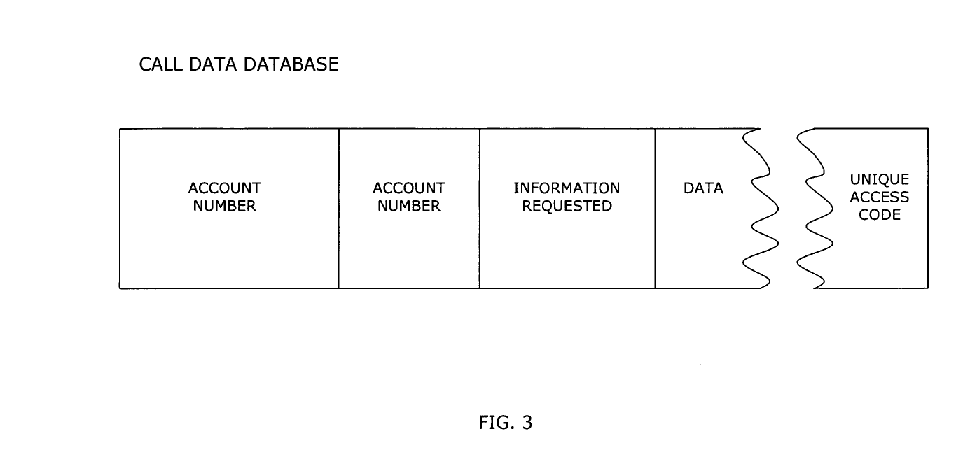

FIG. 3 illustrates one possible data cell utilized in the present invention. The data cell may be, for example, product details or account details. For example, an interested party of a music store selling CDs may want more information on a CD, such as an image of the album cover or an audio segment of the album. The data cell may include an image file of the CD cover or an audio file of an audio segment of the CD. The call center agent may direct the interested party to a website and allow the interested party to access the information. Similarly data cells may include information associated with the address of the stores that has the CD in stock. Another example may include specific information only for the interested party such as account balance.

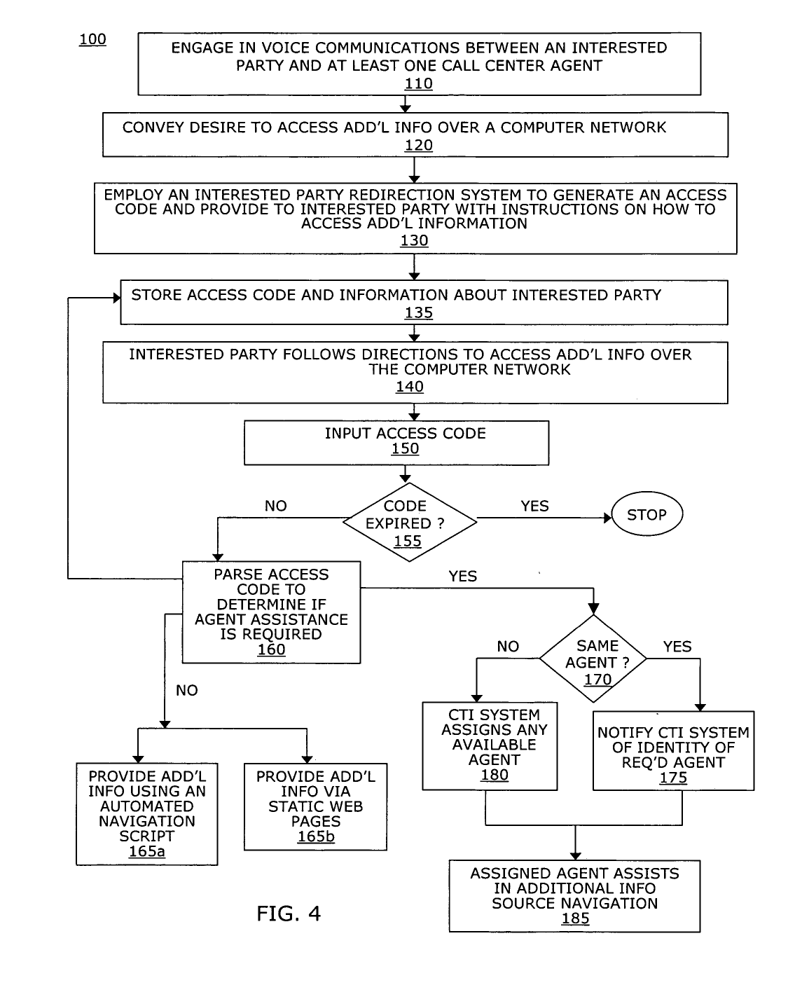

FIG. 4 shows one embodiment of a method of redirecting at least one interested party engaged in communications with a call center agent to at least one additional information source over a computer network. The method 100 begins by an interested party engaging in communications with a call center agent over a communication medium, such as the PSTN or the web, act 110. During the initial communications, the desire or need to access an additional information source over a computer network is conveyed to the call center agent by the interested party or identified by the web server, act 120. The conveyance of the desire or need to access the additional information source may be prompted by either the interested party, the web server or the call center agent.

Once a need to access an additional information source is conveyed to the call center agent, act 130, the call center agent employs an interested party redirection system as disclosed herein to generate an access code (unique or not unique) to provide to the interested party along with directions on how to utilize the access code to access the additional information source. The access code and information about the interested party is stored for later retrieval, act 135.

At some point in time after the conclusion of the communications, the interested party follows the directions that he or she has been provided with and accesses the additional information source over the computer network, act 140.

Once an additional information source is accessed, the interested party will input the access code that she or he has been provided with, act 150. At this point, in act 155, a decision is made as to whether the input access code is valid. If the access code has expired, or is in some other respect invalid, the interested party will not be permitted to obtain the additional information. On the other hand, if the access code is valid, act 160, the access code is parsed to determine if the additional information request requires the assistance of a call center agent. If no call center agent assistance is required, then, in act 165, the additional information is either provided by the additional information source using an automated navigation script (act 165a), in which case the script may be responsive to information stored in a call record stored in the CTI system, or by static web page information that requires no specific navigation on the part of the interested party (act 165b).

If agent interaction is required, a decision is made as to whether the interested party requires the assistance of the same call center agent that handled the initial communications, act 170. Such a decision can be accomplished by a query of the interested party, which is provided by the additional information source at the time it is accessed or could be accomplished during the initial communications. In the latter case, the answer to that question could be stored in the call data database and be linked to the access code.

If the same agent is required, then the additional information source will so notify the CTI system via the computer network and the CTI system will connect the required agent to the additional information source via a computer network interface, act 175. If, on the other hand, any call center agent can assist in the provision of the additional information via the computer network, any available agent will be assigned to the additional information request and will be connected to the additional information source via the computer network, act 180.

Finally, in act 185, the agent assigned to assist in the additional information request will engage in an electronic chat session with the interested party over the computer network to assist the interested party in navigating the additional information source.

Accordingly, the interested party redirection system and method of the present invention provides an access code to an interested party who is engaging in communications with a call center agent, web server or other information source over a communications medium and redirects them to an alternative or additional source of information provided over a computer network.

Modifications and substitutions by one of ordinary skills in the art are considered to be within the scope of the present invention.

What is claimed is:

1. A system for redirecting an interested party engaged in communications with a call center agent over a communication line linking the call center agent to the interested party via a computer telephony integration (CTI) system to an information source accessible by the interested party over a computer network via an interested party computer accessing the computer network, the interested party redirection system featuring:
an information source access code generator, for generating an access code to allow the interested party to access at least one source of information, the access code generator also for linking an assigned access code to a call record maintained in the CTI system, to identify an interested party utilizing the access code to access the source of information;
a computer network interface, for interfacing the call center CTI system to the computer network;
a call record database, for storing information to link an assigned access code to a stored call record; and
a source of information navigation system, responsive to an assigned access code input by a user, for directing the interested party to said at least one source of information over the computer network.

2. The interested party redirection system of claim 1, wherein the computer network includes the Internet World Wide Web and wherein the CTI system network interface includes a web browser.

3. The interested party redirection system of claim 1, wherein the source of information navigation system includes an electronic chat program to allow a call center agent to engage in an electronic chat session with the interested party while the interested party is accessing the at least one source of information, to allow the call center agent to assist the interested party in navigating the alternative source of information.

4. The interested party redirection system of claim 1 further including an automated navigation script generator, responsive to the assigned access code and the call record linked to the assigned unique access code, for generating an automated script to direct the navigation of said at least one source of information based on information stored in the call record.

5. The interested party redirection system of claim 1, wherein the at least one source of information system is at least one web page and wherein the source of information navigation system is a link to the web page(s) providing the desired information.

6. The interested party redirection system of claim 3, wherein the call record database further includes an agent identifier, for identifying an agent engaged in communications with the interested party, for allowing the CTI system to assign the agent to participate in the electronic chat session with the interested party should the interested party desire the same call center agent who initially handled the communications, to assist in the navigation of the at least one source of information.

7. A method for redirecting an interested party engaged in communications with a call center agent over a communication line linking the call center agent to the interested party via a computer telephony integration (CTI) system to at least one source of desired information accessible by the interested party over a computer network via an interested party computer accessing the computer network, the method featuring the acts of:
generating an information source access code assigning said at least one source of information to said access code, for allowing the interested party to access the at least one source of information;
linking the assigned at least one source of information access code to a call record maintained in the CTI system, to identify an interested party who has been assigned the at least one information source access code;
interfacing the call center CTI system to the computer network;
storing the information necessary to link said assigned access code to a stored call record in a call record database; and
assisting an interested party accessing the at least one source of information in navigating the accessed alternative information source over the computer network.

8. The method of claim 7, wherein the alternative source of information includes at least one Internet World-Wide-Web page and further includes the act of interfacing the call center CTI system to the computer network includes employing a Internet Web Browser program to allow a call center agent to interface with the Internet and access the Web page(s) representing the at least one source of information.

9. The method of claim 7, wherein the act of assisting an interested party accessing the alternative information source over the computer network includes engaging a call center agent in an electronic chat session with the interested party over the computer network while the interested party is accessing the at least one information source, to allow the call center agent to assist the interested party in navigating the at least one source of information.

10. The method of claim 7, wherein the act of assisting an interested party accessing the at least one information source over the computer further includes the act of providing an automated navigation script generator, responsive to the assigned access code and the call record linked to the assigned access code, for generating an automated script to direct the navigation of said at least one source of information based on information stored in the call record.

11. The method of claim 7 wherein the communication the interested party is engaged in with the call center agent is a voice communication over a voice communication line linking the call center agent to the interested party.
